(19) United States
(12) Patent Application Publication
(10) Pub. No.: US 2025/0172167 A1
(43) Pub. Date: May 29, 2025

(54) Luggage Ring Assembly

(71) Applicant: Illinois Tool Works Inc., Glenview, IL (US)

(72) Inventors: Ivan Martin MARIÑO, Sabadell (ES); Victor DIEZ HERRERA, Sabadell (ES)

(21) Appl. No.: 18/948,092

(22) Filed: Nov. 14, 2024

(30) Foreign Application Priority Data
Nov. 27, 2023 (EP) 23212405.7
Oct. 29, 2024 (DE) 10 2024 131 618.7

(51) Int. Cl. F16B 21/07; B60R 11/00

(52) U.S. Cl. CPC F16B 21/075; B60R 11/00; B60R 2011/0061

(57) ABSTRACT

Disclosed is a luggage ring assembly, suitable for attachment to a vehicle chassis. The luggage ring assembly includes a luggage ring, and an engagement member connected to the luggage ring. The engagement member includes a nose suitable for insertion through, but not rotation within, a non-circular aperture and a waist suitable for rotation within the non-circular aperture. In use, once the nose passes through a non-circular aperture, rotation of the luggage ring assembly about the waist within the non-circular aperture arranges the nose in an orientation that prevents return of the nose through the non-circular aperture.

### RELATED APPLICATIONS

The present application claims the benefit of European Patent Application No. EP 23212405.7, filed Nov. 27, 2023, and German Application No. DE 10 2024 131 618.7, filed Oct. 29, 2024, each titled “Luggage Ring Assembly,” the contents of which are hereby incorporated by reference.

### TECHNICAL FIELD

The disclosure relates to a luggage ring assembly. In particular, the disclosure relates to a luggage ring assembly which does not require a third-party fixing and has easy attachment.

### BACKGROUND

Known luggage rings fasten to a structure such as a vehicle chassis via a screw and nut, allowing further components, such as a vehicle panel to be fastened. Known luggage rings may also require a welding operation for assembly, such as welding a backing nut to the body in white. The luggage ring must then be screwed onto the backing nut, via a screw. An operative must use a tool to attach the luggage ring. This complicates manufacturing and is time-consuming.

Furthermore, placement of the luggage ring is inflexible. The luggage ring can only be placed at the location of the welded back nut. Relocation, or addition, of luggage rings is difficult, requiring additional back nuts to be welded on. This is undesirable, costly, and requires the services of a trained professional. An end user is unlikely to be able to perform the steps required to move, remove, replace, or add a luggage ring post manufacture of the body in white.

### SUMMARY OF THE DISCLOSURE

The present disclosure relates generally to a luggage ring assembly, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a luggage ring before installation.

FIG. 2 illustrates a luggage ring after installation with a suitable plate structure (e.g. a car chassis).

FIG. 3 illustrates a schematic illustration of the individual steps during installation, e.g. on a vehicle chassis, with the steps of (1) associating the luggage ring with a suitable aperture in the chassis or structure, (2) insertion of the luggage ring through a suitable aperture in the chassis or structure, (3) rotation of the luggage ring within the aperture, and (4) engagement of a clip or lock to hold the luggage ring in position.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

The illustrated example embodiment(s) relates to luggage rings, and in particular to luggage rings that are installed to a structure, such as, for example, a chassis of a vehicle, via a concealed fastener, thus, providing improved case of use during installation.

According to the disclosure there is presented a luggage ring assembly, suitable for attachment to a vehicle chassis, comprising: a luggage ring; an engagement member connected to the luggage ring; wherein the engagement member comprises a nose suitable for insertion through, but not rotation within, a non-circular aperture; a waist suitable for rotation within the non-circular aperture; wherein in use, once the nose passes through a non-circular aperture, rotation of the luggage ring assembly about the waist within the non-circular aperture arranges the nose in an orientation that prevents return of the nose through the non-circular aperture. The idea here is that the luggage ring assembly may, in a certain orientation, pass through a non-circular aperture. The luggage ring assembly is then rotated by an amount, after which, elements of the luggage ring assembly are arranged with respect to the non-circular aperture, such that those elements are misaligned with the non-circular aperture and may no longer return through the non-circular aperture. The nose is an example of such an element. Installation is therefore simple, requiring only alignment and twisting the luggage ring assembly relative to the non-circular aperture. Non-circular apertures may be provided at any desired location to allow for installation of the luggage ring assembly, or additional non-circular apertures may be added by a third party at a later date. A waist is provided to allow rotation of the luggage ring assembly within the non-circular aperture once located appropriately within the non-circular aperture. The waist may be fully rotatable 360° within the aperture or partially, provided that the shape of the waist permits sufficient manipulation/translation/or rotation of the luggage ring assembly to arrange the elements (e.g. Nose) of the luggage ring assembly into a position where return passage through the non-circular aperture is impossible without first reversing the manipulation/translation/rotation performed to arrange the luggage ring assembly within the non-circular aperture in the first place. In other words, the rotation is a yaw movement relative to the insertion direction of the luggage ring assembly with respect to the non-circular aperture.

Preferably, the nose comprises a cross section that substantially describes the shape of the non-circular aperture. The description of the shape of the non-circular aperture may correspond to a perimeter shape or cross-section of the non-circular aperture, but slightly smaller in order to allow passage of the nose through the non-circular aperture in one orientation. Once through the aperture, rotation of the nose then places the shape of the nose out of alignment with the shape of the non-circular aperture, such that the features that allowed passage of the nose through the non-circular aperture snarl, interfere, or otherwise fouls upon the same features of the non-circular aperture. This is exemplary, the nose and/or non-circular aperture may be provided with additional or different features that exhibit the same function (i.e. Ensure features of the nose snarl/interfere/or foul upon the non-circular aperture). The features which engage between the nose and the non-circular aperture may be the same (i.e. The relevant feature of the non-circular aperture described by the nose may be that which snarl/fouls/interferes with the described feature of the non-circular aperture) or different (i.e. The a feature of the nose that is not, or is different to, the feature of the non-circular aperture described by the nose may be that which snarl/fouls/interferes with the described feature of the non-circular aperture). It is not essential that the nose comprises a cross-section that describes a cross section of the non-circular aperture, nut the nose should be shaped such that it may perform its function, which is to be inserted in a direction aligned with a non-circular aperture and then rotated about an axis that is parallel with the direction of insertion, and that features of the nose are then arranged relative to the non-circular aperture such that the nose may not return through the non-circular aperture when a force is applied in the opposite direction to the insertion direction.

Suitably, the nose comprises an abutment surface arranged to resist return of the nose through a non-circular aperture. The abutment surface provides a bulwark which resists return of the nose through the non-circular aperture, such a feature imbues the luggage ring assembly with a capacity to tolerate a predetermined load of luggage to bear upon the luggage ring assembly without the nose tearing out of the non-circular aperture.

Appositely, a rotation of 30° or greater of the luggage ring assembly about the waist within the non-circular aperture is required to arrange the nose in an orientation that prevents return of the nose through the non-circular aperture. A minimum amount of rotation to lock the luggage ring assembly in place is advantageous in providing a reassuring installation process. A fiduciary feature may be present to indicate to an installer that sufficient manipulation/translation/rotation of the luggage ring assembly has occurred and that the luggage ring assembly is successfully installed. Suitable fiduciary features include visual/topological location markers or audible location noises (e.g. A click).

Appropriately, the engagement member further comprises an arresting surface arranged to allow location within, but resist passage through, of the waist in the non-circular aperture. The arresting surface prevents the luggage ring assembly from being inserted too far within the non-circular aperture, this makes installation easier as the luggage ring assembly cannot be miss-placed within the non-circular aperture. The arresting surface may be arranged in opposition to one or more abutment surfaces which are described above. The arresting surface and abutment surface may work in unison to resist tear-out of the luggage ring assembly from the non-circular aperture by an applied luggage load.

Preferably, the engagement member further comprises at least one tensioning arm arranged to, in use apply tension to the luggage ring assembly, and optionally wherein the applied tension urges the nose towards the non-circular aperture. The tensioning arm ensures that the luggage ring assembly will not move within, about, or relative to the non-circular aperture unless that movement is intentionally made by a user. Furthermore, the luggage ring assembly may be manufactured to be used with broad spectrum of substrates having different manufacturing material thickness tolerance (that is how consistently thick a material is) and/or material thicknesses (i.e. The rated average thickness of material which is separate to the consistency of the thickness at any given point in the material). The tensioning arm cinches the luggage ring assembly against the substrate and absorbs any slack movement or play between the luggage ring assembly and the substrate. A single luggage ring assembly may therefore be suitable for use with a variety of substrates each having different properties/dimensions.

Suitably, the engagement member comprises a rotation lock to lock the position of the waist within a non-circular aperture. The rotation lock may be arranged to engage with a feature of the non-circular aperture upon rotation of the luggage ring assembly by a predetermined amount e.g. The amount required to arrange the nose in position so that the nose may not return through the non-circular aperture. Once engaged, the engagement member prohibits unintentional rotation of the nose relative to the non-circular aperture. The engagement member may engage reversibly or irreversibly.

Appropriately, the rotation lock is a resilient member adjacent the waist, such that the resilient member is biased away from the waist in order to capture and snarl, foul, or otherwise interfere with features of the non-circular aperture.

Appositely, the rotation lock is arranged to interfere with a vertex of a non-circular aperture. The vertex may be provided specifically for cooperation with the resilient member or may be an existing feature, such as one intended for description by part of the nose. The vertex should provide a well or trap from which the resilient member, once within, cannot unintentionally escape.

Suitably, the engagement member is formed by stamping or pressing. Such that manufacture of the luggage ring assembly is in a minimum number of steps and does not require welding, adhesives, or human-operated fixations. The luggage ring assembly may be formed from two separate pieces, the luggage ring and the engagement member. The engagement member formed from a single piece of material.

Preferably, the luggage ring is rotatable relative to the engagement member, in order to allow the luggage ring to be orientated relative to the engagement member (and therefore the substrate to which the engagement member is attached) in a position which suits a user's needs. The luggage ring may be arranged to move with one or more of pitch, yaw, and roll relative to the engagement member.

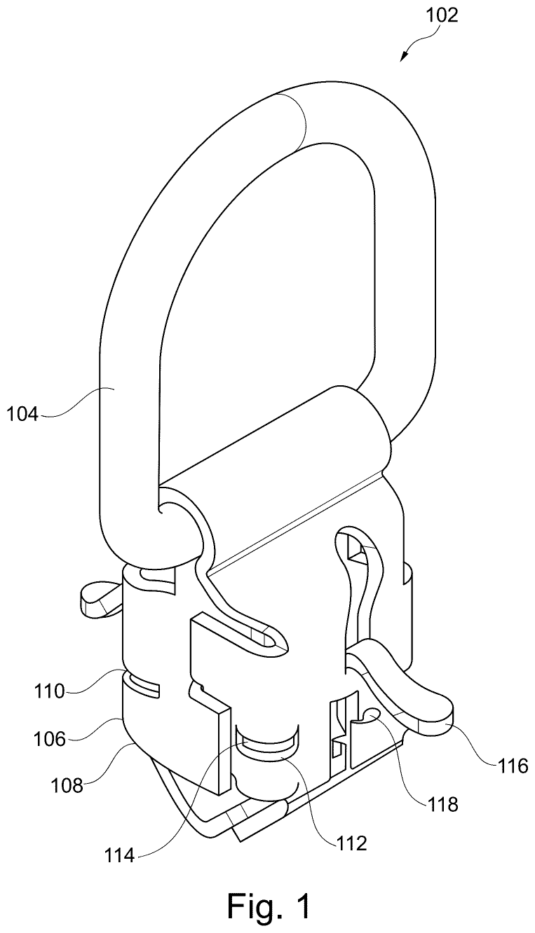

FIG. 1 shows a luggage ring assembly 102 having a compact ergonomic design. The luggage ring assembly 102 is intended to be ready for manual (by hand, without tools) assembly. The luggage ring assembly 102 has a luggage ring 104 to which luggage may be attached, suspended, or secured. The luggage ring 104 may be a solid metal ring, but any material may be used provided the material is sized and suitable to allow the luggage ring assembly 102 to perform its function (to provide a securing point to luggage). “Luggage” may vary depending on the vehicle and location within the vehicle, luggage in a small car may be a lightweight suitcase or shopping bag, compared to an aircraft or lorry where the “luggage” may be heavy crates. The assembly step is intuitive facilitating easy assembly/disassembly. An anti-rotation system is included by way of an engagement member 106 that provides a locking feature that prevents reverse-rotation of the luggage ring into a position by which it may leave the aperture. The degree of rotation required to fit the ring may be small, such as ⅛th of turn to perform the assembly. The rotation is typically in a yaw direction relative to an axis described by an insertion direction the engagement member 106 into a non-circular aperture.

A nose 108 is provided for insertion into a non-circular aperture. The nose 108 of the luggage ring assembly, when inserted into the non-circular aperture and rotated, is then arranged with respect to the non-circular aperture, such that the nose 108 is misaligned with the non-circular aperture and may no longer return through the non-circular aperture. The non-circular aperture may be, for example, a square (although any non-circular aperture may function) and the shape of the nose may have a cross section describing the square, but slightly smaller such that it may pass through the square. On rotation the vertices of the square cross section described by the nose are then arranged in alignment with the sides of the square shaped non-circular aperture. As the distances between the diagonal vertices of a square is greater than the distance between parallel walls of the square shaped non-circular aperture, the vertices of the square cross section described by the nose foul, snarl upon, or otherwise interfere upon the non-circular aperture, thereby preventing return of the nose 108 through the square shaped non-circular aperture.

A waist 110 is provided to allow the engagement members 106 to rotate in a yaw direction within the non-circular aperture. The waist 110 allows rotation of the luggage ring assembly within the non-circular aperture once located appropriately within the non-circular aperture. The waist may be fully rotatable 360° within the aperture or partially, provided that the shape of the waist permits sufficient manipulation/translation/or rotation of the luggage ring assembly to arrange the nose 108 of the luggage ring assembly into a position where return passage through the non-circular aperture is impossible without first reversing the manipulation/translation/rotation performed to arrange the luggage ring assembly within the non-circular aperture in the first place.

The engagement member 106 may be further provided with an abutment surface 112 and/or an arresting surface 114 which are arranged to contact and resist passage of the engagement member 106 through the non-circular aperture. The abutment surface 112 is arranged to only engage the engagement member 106 once the nose is inserted and rotated into an interfering fit with the non-circular aperture. The arresting surface 114 may contact and prevent passage of the waist 110 through the non-circular aperture prior to rotation of the nose 108 into interfering fit within the non-circular aperture. The abutment surface 112 is arranged to pass through the non-circular aperture prior to contact of the arresting surface 114 with the substrate in which the non-circular aperture is formed.

One or more tensioning arms 116 are provided which apply a tension to the luggage ring assembly and the substrate in which the non-circular aperture is formed. Optionally the applied tension urges the nose 108 towards the non-circular aperture. The tensioning arm 116 ensures that the luggage ring assembly will not move within, about, or relative to the non-circular aperture unless that movement is intentionally made by a user. Furthermore, the luggage ring assembly may be manufactured to be used with a broad spectrum of substrates having different manufacturing material thickness tolerance and/or material thicknesses. The tensioning arm 116 may take the form of a sprung resilient member formed unitarily with the engagement member 106.

Similarly, a rotation lock 118 may be provided to prevent rotation in a yaw direction once the engagement member 106 is located within the non-circular aperture in a final position. The rotation lock 118 is arranged to interfere with a vertex of a non-circular aperture. The vertex may be provided specifically for cooperation with the resilient member or may be an existing feature, such as one intended for description by part of the nose. The vertex should provide a well or trap from which the resilient member, once within, cannot unintentionally escape.

No welded nut is required on the body in white to fit the luggage ring. No screw or other separate fastener is required to fit the luggage ring. No special manufacturing processes or welding is required to fit the luggage ring. To be able to accept the luggage ring the only preparation is the formation of a square aperture on the substrate (or any other suitable shape to accept the luggage ring).

The luggage ring disclosed herein is light weight at approximately 44 g per luggage ring, for example. This represents a 45% weight saving on prior art luggage rings used in similar applications.

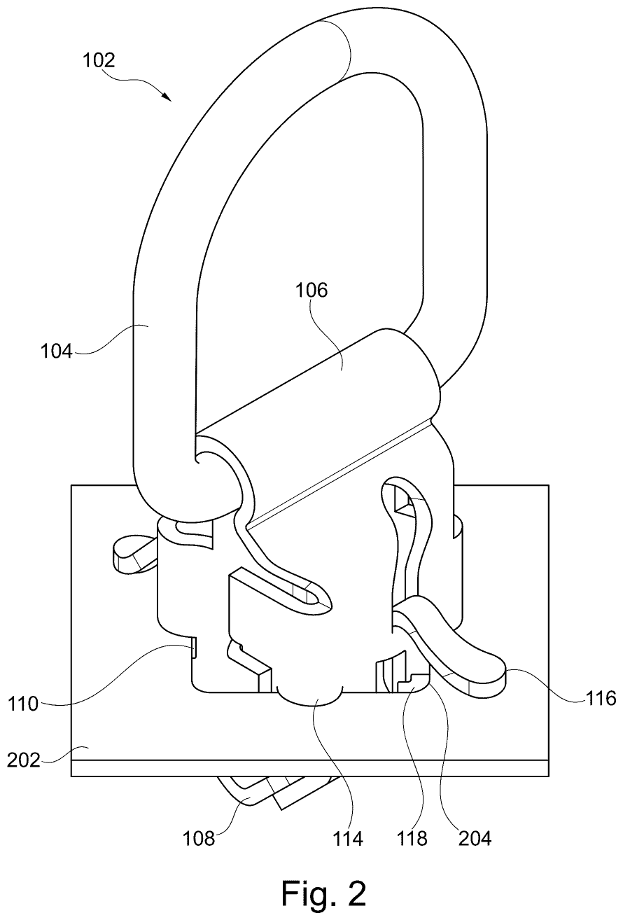

FIG. 2 shows the luggage ring assembly 102 of FIG. 1 fitted within a non-circular aperture formed in a vehicle chassis 202 and rotated into a locked position. Tensioning arms 116 act upon the vehicle chassis 202 thereby preventing movement of the luggage ring relative to the substrate. The rotation lock 118 is shown engaged with a vertex 204 of the non-circular aperture thereby preventing movement in a yaw direction of the engagement member 106.

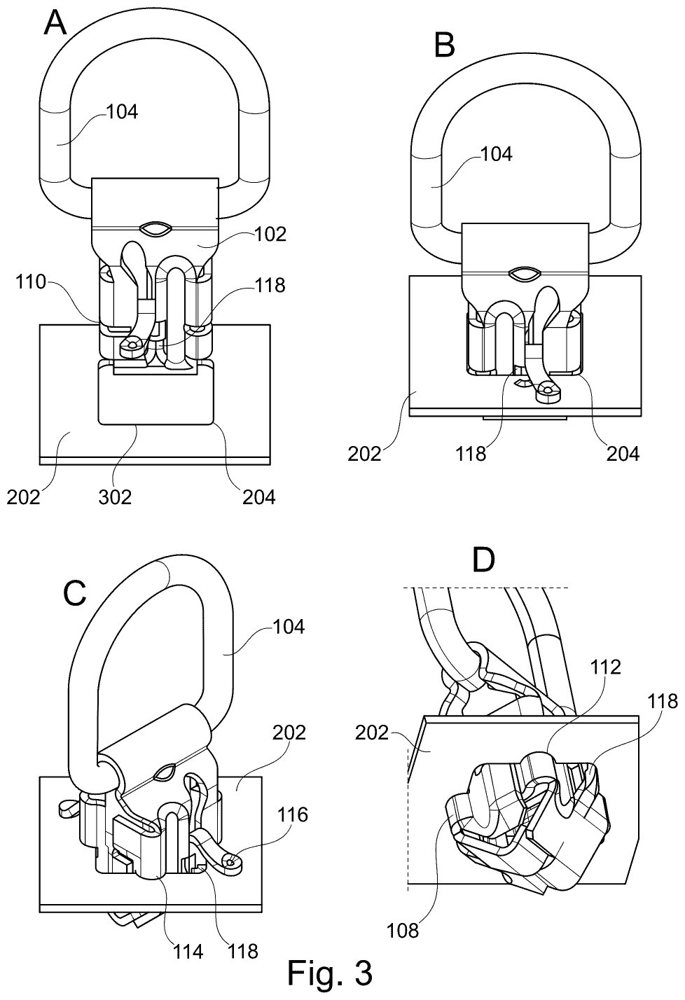

FIGS. 3 (a), (b) and (c) shows a series of illustrations of the luggage ring assembly 102 being installed on a vehicle chassis 202. The vehicle chassis 202 has a substantially planar structure having a first non-circular aperture 302 suitable to receive and push through the gripping means of the luggage ring assembly. Once pushed through the aperture the luggage ring is rotated by a finite amount, until a locking feature (the rotation lock 118) engages preventing further rotation (forward or reverse) and locking the luggage ring in place. This may be performed without tooling (i.e. by hand). The process of assembly may be reversible (e.g. by manually disengaging the locking feature and then reversing the fitting process.

Therefore, the luggage ring assembly provides improved ease of assembly and negates the need for tools or extra fixing.

Further, the luggage ring assembly may provide minimized weight due to reduction of screw or bolt sizes and less parts.

To provide for the luggage ring assembly, there is no welding required, simply a suitably shaped aperture (such as a square) suitable to receive the fastener plate.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A luggage ring assembly (102), suitable for attachment to a vehicle chassis (202), comprising:
a luggage ring (104); and
an engagement member (106) connected to the luggage ring;
wherein the engagement member comprises
a nose (108) suitable for insertion through, but not rotation within, a non-circular aperture (302); and
a waist (110) suitable for rotation within the non-circular aperture;
wherein in use, once the nose passes through a non-circular aperture, rotation of the luggage ring assembly about the waist within the non-circular aperture arranges the nose in an orientation that prevents return of the nose through the non-circular aperture.

2. The luggage ring assembly of claim 1, wherein the nose comprises a cross section that substantially describes the shape of the non-circular aperture.

3. The luggage ring assembly of claim 1, wherein the nose comprises an abutment surface (112) arranged to resist return of the nose through a non-circular aperture.

4. The luggage ring assembly of claim 1, wherein a rotation of 30° or greater of the luggage ring assembly about the waist within the non-circular aperture is required to arrange the nose in an orientation that prevents return of the nose through the non-circular aperture.

5. The luggage ring assembly of claim 1, wherein the engagement member further comprises an arresting surface (114) arranged to allow location of the waist within, but resist passage through, the non-circular aperture.

6. The luggage ring assembly of claim 1, wherein the engagement member further comprises at least one tensioning arm (116) arranged to, in use apply tension to the luggage ring assembly, and optionally wherein the applied tension urges the nose towards the non-circular aperture.

7. The luggage ring assembly of claim 1, wherein the engagement member comprises a rotation lock (118) to lock the position of the waist within a non-circular aperture.

8. The luggage ring assembly of claim 7, wherein the rotation lock is a resilient member adjacent the waist.

9. The luggage ring assembly of claim 7, wherein the rotation lock is arranged to interfere with a vertex (204) of a non-circular aperture.

10. The luggage ring assembly of claim 7, wherein the engagement member is formed by stamping or pressing.

11. The luggage ring assembly of claim 7, wherein the luggage ring is rotatable relative to the engagement member.
